(19) United States
(12) Patent Application Publication
(10) Pub. No.: US 2024/0241488 A1
(43) Pub. Date: Jul. 18, 2024

(54) BUILDING AUTOMATION SYSTEM FOR SMART EDGE MANAGEMENT

(71) Applicant: Building Robotics, Inc., Oakland, CA (US)

(72) Inventor: Dale Gass, Oakville (CA)

(73) Assignee: Building Robotics, Inc., Oakland, CA (US)

(21) Appl. No.: 18/155,434

(22) Filed: Jan. 17, 2023

(51) Int. Cl. G05B 15/02; H04L 67/12

(52) U.S. Cl. CPC G05B 15/02; H04L 67/12; G05B 2219/2642

(57) ABSTRACT

There is a building automation system for smart edge management including first, second, and third agents, and a telemetry transport broker coupled to the agents. The first and second agents receive system data from external networks associated with field devices of one or more buildings. The first agent is associated with a first communication protocol, and the second agent is associated with a second communication protocol. The first and second agents publish first and second messages to the broker based on the system data. The third agent publishes a third message to the broker without regard to the external networks. The messages are associated with topics of the broker, and one or more agents subscribe to at least one topic of the broker. The broker forwards messages associated with a particular topic of the topics of the broker to the agent(s) subscribed to the particular topic.

### FIELD OF THE INVENTION

This application relates to the field of building management systems and, more particularly, to a building automation system for smart management of edge devices.

### BACKGROUND

Building management systems encompass a wide variety of systems that aid in the monitoring and control of various aspects of building operation. Building management systems include security systems, fire safety systems, lighting systems, and heating, ventilation, and air conditioning (“HVAC”) systems. The elements of a building management system may be widely dispersed throughout a facility or campus.

Building management systems typically have one or more centralized control stations in which data from the system may be monitored, and in which various aspects of system operation may be controlled and/or monitored. The control station typically includes a computer or server having processing equipment, data storage equipment, and a user interface. To allow for monitoring and control of the dispersed control system elements, building management systems often employ multi-level communication networks to communicate operational and/or alarm information between operating elements, such as sensors and actuators, and the centralized control station.

Convention systems utilize a semantic data model to unify inputs from various vendors. Harmonization of incoming data is inadequate since the exchange and communication of data between different sensor networks and building systems is not developed for real-time applications.

### SUMMARY

In accordance with one embodiment of the disclosure, there is provided a smart management approach for edge devices. The approach deploys smart building telemetry and control applications that collect data and interact with devices and sensor networks from various sources, via proprietary protocols and/or standard communication protocols. The approach also provides a building automation system to implement critical infrastructure functions that are time sensitive, with low-latency or real-time response requirements. In particular, a building automation system includes a telemetry transport broker utilizing a topic tree for smart edge management. The system provides flexibility, extensibility, security, resiliency, as well as improved response time. The system includes containerized agents for interfacing and logic allow for adding new applications and on-boarding new logic blocks and interfaces with ease. The system further includes a topic tree that is extendible so that new data types for telemetry may be added or new commands may be used without disrupting existing functionality. Data may be processed and used the telemetry transport broker to achieve fast response time to meet critical applications with low latency response requirements. Data may also be processed on premise to prevent exposure to cyberattacks and provide the option to retain sensitive data on site, versus on cloud storage and processing systems. Further, the edge platform may operate even when cloud connectivity is lost.

One aspect is a building automation system for smart edge management comprising a first interface agent, a second interface agent, and third interface agent, and a telemetry transport broker. The first and second interface agents receive system data from external networks associated with field devices of one or more buildings. The first interface agent manages a first type of the system data associated with a first communication protocol. The second interface agent manages a second type of the system data associated with a second communication protocol different from the first communication protocol. The telemetry transport broker is coupled to the first and second interface agents and a third interface agent. The first and second interface agents publish first and second telemetry transport messages to the telemetry transport broker based on the system data. The third interface agent publishes a third telemetry transport message to the telemetry transport broker without regard to the external networks. The telemetry transport messages are associated with topics of the telemetry transport broker. One or more interface agents subscribe to at least one topic of the telemetry transport broker. The telemetry transport broker forwards telemetry transport messages associated with a particular topic of the topics of the telemetry transport broker to the interface agent or agents subscribed to the particular topic.

Another aspect is a method of a building automation system for smart edge management. System data from external networks associated with field devices of one or more buildings is received at first and second interface agents. The first interface agent manages a first type of the system data associated with a first communication protocol. The second interface agent manages a second type of the system data associated with a second communication protocol different from the first communication protocol. Telemetry transport messages are published at a telemetry transport broker by the first and second interface agents based on the system data. A telemetry transport message is published to the telemetry transport broker without regard to the external networks. The telemetry transport messages are associated with topics of the telemetry transport broker. One or more topics of the telemetry transport broker are subscribed by one or more interface agents. The telemetry transport broker forwards telemetry transport messages associated with a particular topic of the topics of the telemetry transport broker to the interface agent or agents subscribed to the particular topic.

Yet another aspect is a non-transitory computer readable medium including executable instructions which, when executed, causes at least one processor to provide smart edge management of a building automation system to execute the method described above.

The above-described features and advantages, as well as others, will become more readily apparent to those of ordinary skill in the art by reference to the following detailed description and accompanying drawings. While it would be desirable to provide one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects.

FIG. 1 is an illustration of a building management system including an edge platform in an example implementation that is operable to employ techniques described herein.

FIG. 2 is an illustration of another edge platform of a building management system in an example implementation that is operable to employ techniques described herein.

FIG. 3 is a block diagram of the edge platform of FIG. 1 or 2 in an example implementation.

FIG. 4 (including FIGS. 4A and 4B) is a flow diagram depicting operations of the telemetry transport broker of FIG. 1 or 2 in an example implementation interacting with various agents of the edge platform for agent initialization and key updates.

FIG. 5 is a flow diagram depicting operations of the telemetry transport broker interacting with a manage agent, gateway agent, and associated components of the edge platform of FIG. 1 or 2 in an example implementation.

FIG. 6 is a flow diagram depicting operations of the telemetry transport broker interacting with a platform agent, configuration agent, dashboard agent, various agents, and associated components of the edge platform of FIG. 1 or 2 in an example implementation.

FIG. 7 is a flow diagram depicting operations of the telemetry transport broker interacting with a KNX agent, BACnet agent, client data lake/BOS agent and associated components of the edge platform of FIG. 1 or 2 in an example implementation.

FIG. 8 is a flow diagram depicting operations of the telemetry transport broker interacting with an area agent, light control agent, and associated components of the edge platform of FIG. 1 or 2 in an example implementation.

### DETAILED DESCRIPTION

Various technologies that pertain to systems and methods that facilitate smart management for edge devices will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

The building automation system for smart edge management is based on an edge processing platform including a machine-to-machine network for message queuing services of telemetry data, i.e., telemetry transport broker. An example of the telemetry transport broker includes, but is not limited to, a machine-to-machine network that implements a publish-subscribe messaging protocol for telemetry data, such as a MQ Telemetry Transport (“MQTT”) broker. The telemetry transport broker receive data from publishers that send data (“publish”) and forwards the data to one or more subscribers that wish to receive data (“subscribe”). The telemetry transport broker may buffer data and provide it to a subscriber at a later time when a connection to a publisher and/or subscriber is not available. Publishers and subscribers communicate with the telemetry transport broker via telemetry transport sessions. Each session includes a connection stage, an authentication stage, a communication stage, and a termination stage.

For the building automation system, interface agents publish and subscribe with the telemetry transport broker. The interface agents convert data incoming from various sources to a shared topic tree to reflect telemetry information and provide an interface to command the machine-to-machine network. For example, an interface agent, such as a logic agent, may act on data topics and product commands while being agnostic to the source of the data. In this manner, the telemetry transport broker passes data between different interface agents without introducing any overhead and provides extensibility to onboard new data types, including future applications. In particular, the building automation system hosts interface agents as containers to allow the addition of new blocks in the future, thus creating an extendible platform. The system also allows pre-existing logic hosted on the cloud to be containerized and moved to the edge platform to achieve timing goals.

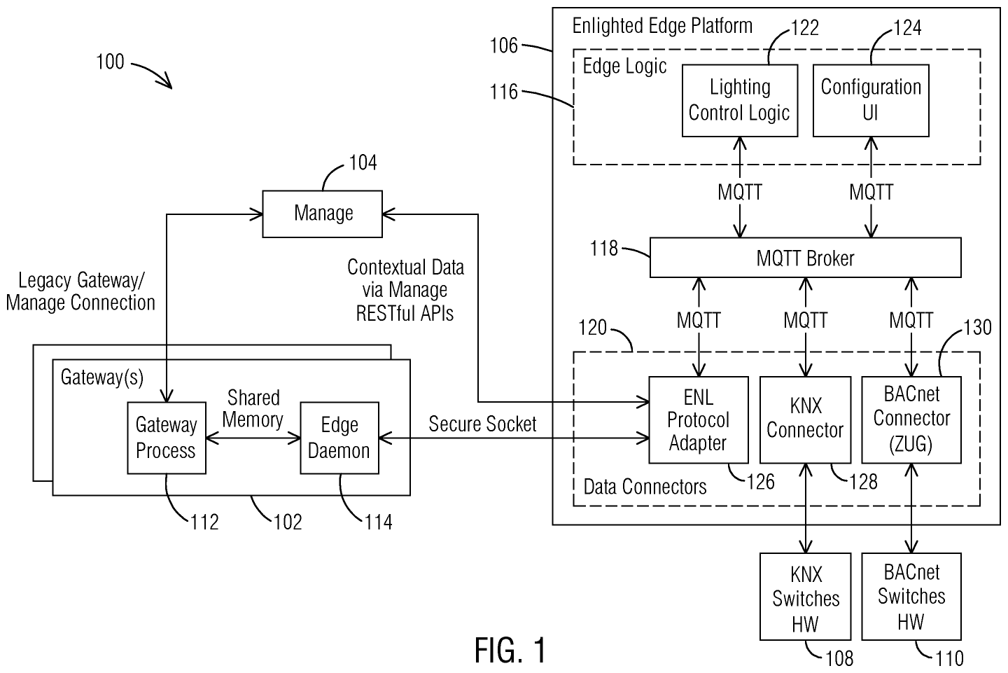

Referring to FIG. 1, there is shown an illustration of a building management system 100 that is operable to employ techniques described herein. The system 100 includes one or more gateways 102, a manage device 104, an edge platform 106, and one or more external devices or networks 108, 110. The gateways allow data to flow from one discrete network to another. For example, each gateway 102 may include a gateway unit 112 to communicate with the manage device 104 via a legacy/manage connection and an edge daemon 114 to communicate with the edge platform 106 as a background process via a second socket connection. For such embodiments, the gateway unit 112 and the edge daemon 114 may operate on the same processor or coordinate operation on one or more processors and shared memory within the gateway 102. The gateway unit 112 and the edge daemon 114 communicates via wired and/or wireless links with field devices of the building automation system 100, such as sensors, switches, programmable logic controls, and the like.

As stated above, the system 100 includes the manage device and one or more external devices or network 108, 110. The manage device 104 receives data from the field devices of the building automation system via the gateways 102. For example, the manage device 104 may receive sensor data, such as transport layer security communications, from the gateway unit 112 of the gateway 102. The system 100 may utilize a standard protocol, a proprietary protocol, or a combination of standard and proprietary protocols to manage devices and/or networks. For some embodiments, one or more external devices or networks 108, 110 may be field devices of the building automation system 100 having data communications capabilities that may utilize a standard network protocol such as, but not limited to, Konnex (KNX) 108, Building Automation and Control networks (BACnet) 110, Universal Device Management Interface (UDMI), or Digital Twin Definition Language (DTDL). For some embodiments, the external devices or networks 108, 110 include equipment that may utilize proprietary protocols and/or open standards for managing an environmental network of one or buildings or Internet-of-Things (“IoT”) devices, such as equipment operating in or with HVAC, lighting, security, fire safety, and other building automation devices and networks.

The edge platform 106 of the building automation system 100 includes edge components 116, a telemetry transport broker 118, and data connectors 120. The edge logic components 116 include interface agents that receive data and send control signals via the telemetry transport broker 118 to the manage devices of the building automation system 100, such as lighting control agents 122 and configuration agents 124. The telemetry transport broker 118 passes data between different interface agents via shared telemetry transport messages without introducing any overhead while providing extensibility to other data types. The data connector components 120 include, but are not limited to, an interface agent associated with an environmental network protocol 126, a KNX connector agent 128, and a BACnet connector agent 130. For example, the environmental network agent 126 may communicate secure socket data with the edge daemon 114 of one or more gateways 102 and contextual data via manage RESTful APIs with the manage device 104.

The interface agents 126, 128, 130 of the data connector component 120 publish telemetry transport messages to the telemetry transport broker 118 based on system data from external networks 102, 104, 108, 110, and the interface agents 122, 124 publish telemetry transport messages to the telemetry transport broker without regard to the external networks. For the interface agents 126, 128, 130 of the data connector component 120, system data is received from the external networks 102, 104, 108, 110 associated with field devices of one or more buildings. Also, in reference to the data connector component 120, a first interface agent 126 manages a first type of the system data associated with a first communication protocol, and a second interface agent 128, 130 manages a second type of the system data associated with a second communication protocol different from the first communication protocol. While interface agents publish telemetry transport messages to the telemetry transport broker 118, one or more interface agents subscribe to one or more topics of the telemetry transport broker. The telemetry transport broker 118 forwards telemetry transport messages associated with a particular topic of the telemetry transport broker to one or more interface agents subscribed to the particular topic.

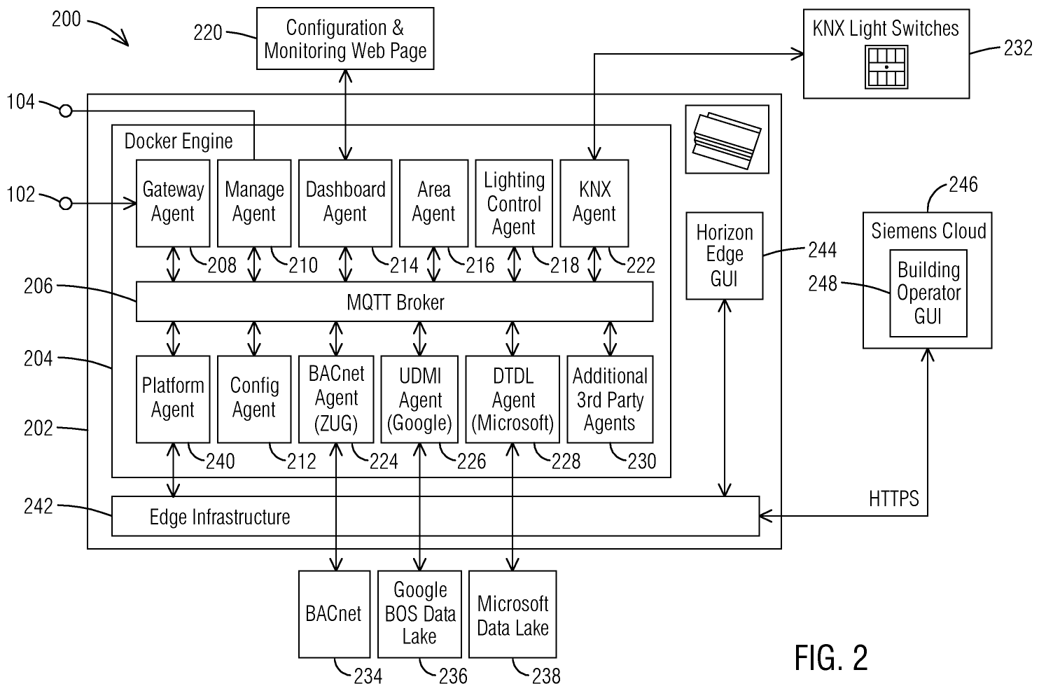

Referring to FIG. 2, there is shown an illustration of another edge platform and associated devices 200 of a building management system in an example implementation that is operable to employ techniques described herein. The building automation system 100 includes an edge platform 202 coupled to the gateways 102 and the manage device 104. For some embodiments, the edge platform may include a docker engine 204 but may function without it. The edge platform 202 includes a telemetry transport broker 206 in which a gateway agent 208 is coupled to the gateways 102 and a manage agent 210 is coupled to the manage device 104. For example, the gateway agent 208 may communicate with the edge daemon 114 of the gateway 102 via transport layer security-transmission control protocol communication, and the manage agent 210 may communicate with a manage interface, such as a RESTful API, of the manage device 104 via https communication. The manage agent 210 maintains a connection with the manage device 104, retrieves hierarchy and status from the manage device, and allows the sending of commands to the manage device. The gateway agent 208, one launched per gateway 102, handles a copy of raw network traffic between the manage device 104 and various field devices. The gateway agent 208 also parses raw traffic data and publishes the information to various topics, as well as handling topics that result in traffic being injected to the field device connection or manage connection.

The building automation system 100 for smart edge management includes at least a first interface agent, a second interface agent, and a third interface agent, all of which are coupled to the telemetry transport broker 206. The first and second interface agents receive system data from external networks 102, 104, 234, 236, 238 associated with field devices of one or more buildings. The first interface agent manages a first type of the system data associated with a first communication protocol, and the second interface agent manages a second type of the system data associated with a second communication protocol different from the first communication protocol. For some embodiments, the first interface agent manages the first type of the system data associated with an environmental network protocol for building automation. The second interface agent manages the second type of system data associated with a proprietary or standard network protocol. Examples of standard network protocols include, but are not limited to, Building Automation and Control networks (BACnet), Konnex (KNX), Universal Device Management Interface (UDMI), or Digital Twin Definition Language (DTDL).

The first and second interface agents publish first and second telemetry transport messages to the telemetry transport broker based on the system data. The third interface agent publishes a third telemetry transport message to the telemetry transport broker without regard to the external networks. The telemetry transport messages are associated with topics of the telemetry transport broker. Examples of the one or more topics of the telemetry transport broker include, but are not limited to, a gateway topic, a sensor topic, a room control topic, switch group topic, an agent topic, an area topic, a configuration topic, or a platform. One or more interface agents subscribe to one or more topics of the telemetry transport broker. For some embodiments, the third interface agent is a lighting control agent for the one or more buildings in which the third interface agent subscribes to one or more topics of the telemetry transport messages associated with the field devices of the one or more buildings. For some embodiments, the third interface agent is a configuration agent for managing configuration parameters for all interface agents publishing and/or subscribing to the telemetry transport broker. The telemetry transport broker forwards telemetry transport messages associated with a particular topic of the topics of the telemetry transport broker to one or more interface agents subscribed to the particular topic.

Examples of the first interface agent include, but are not limited to, the gateway agent 208 and the manage agent 210. The gateway agent 208 obtains a copy of raw network traffic from a gateway 102. The data is then parsed, and the status of field devices is published to the telemetry transport broker 206. Similarly, the gateway agent 208 subscribes to telemetry transport topics for commanding field devices, and constructs and sends packets to the gateway to be injected to the field device network. The gateway agent 208 facilitates the translation between the telemetry transport interface and the communication protocol used by the field device, such as the sensors, gateways, ERCs, etc. The manage agent 210 gathers contextual information from an instance of the manage device 104. The contextual data is published to the telemetry transport broker 206, providing other interface agents a hierarchy of accessible devices and how they are arranged within the building or buildings.

Examples of the third interface agent include, but are not limited to, a configuration agent 212, a dashboard agent 214, an area agent 216, and lighting control agent 218. For the configuration agent 212, configuration data of the edge platform 202 is stored in a database. The configuration agent 212 manages the database and provides a process for agents to view and update their required configuration parameters. At initialization, agents publish their requested key names and metadata to a registration topic, which the config agent uses to perform validation of database entries and to distribute the requested config key value pairs. The dashboard agent 214 communicates via wired or wireless link to a remote edge platform device 220 that is capable of configurating and monitoring the docker engine 204 (for some embodiments), edge platform 202, and/or the system 100. For some embodiments, the dashboard agent 214 may use PyWebIO to generate a dynamic GUI used to display configuration parameters. The GUI also allows a user to input desired configuration information to the displayed fields, and dashboard agent may publish requests to the configuration agent to perform updates to the database. The area agent 216 monitors traffic of the building automation system 100 to determine the status of areas within the building(s) and publish the data to the telemetry transport broker 206. The area agent 216 provides, for example, information associated with the occupancy of one or more areas and the number of non-responsive sensors that exist within each area. The lighting control agent 218 manages the illumination commands for switch groups of environmental networks, such as dimming commands for a lighting control system. For example, when a dimming command is issued, the lighting control agent 218 may maintain a timer for the switch group and issue dim step commands at regular intervals.

For embodiments that utilized standardized building protocols, examples of interface agents that manage external networks include, but are not limited to, a KNX agent 222 and a BACnet agent 224. The KNX agent 222 provides an interface for controlling field device sensors and switch groups using third-party KNX switches/buttons 232. For some embodiments, the KNX switches 232 are configured with a specified group address format that includes the switch group identification as part of the address. The KNX agent 222 monitors traffic on a KNX IP bus for commands to these special KNX group addresses and publishes the appropriate command(s) to the target switch group. The BACnet agent 224 exposes field devices as objects/points on a BACnet network. The BACnet agent 224 enables the control of field device sensors and switch groups through a BACnet interface.

For embodiments that utilize standardized IoT protocols, examples interface agents that manage external networks include, but are not limited to, a Universal Device Management Interface (“UDMI”) agent 226 and a Digital Twin Definition Language (“DTDL”) agent 228. The UDMI agent 226 may be used to interface traffic of the building automation system 100 with a Cloud IoT platform based on the UDMI protocol. The UDMI agent 226 provides a set of schemas and specifications to standardize the interface to various devices in a GCP IoT project. The DTDL agent 228 converts system data to a payload format used for IoT communication in DTDL-based campuses. Device telemetry and health are published to external network through an event hub of the network. The edge platform 202 may also include one or more 3rd party agents 230 to manage other types of external networks of the building automation system 100.

The edge platform 202 may further include a platform agent 240 that may serve as an abstraction layer allowing edge platform 202 to be portable to different hosts/hardware. The platform agent 240 publishes the state and details of networking interfaces on the host, and the agent provides a mechanism for other agents to request the opening of ports on the device and obtain information about the host system, such as a list of network interfaces and IP addresses. For some embodiments, the edge platform 202 may include an edge infrastructure coupled to the platform agent 240 to provide a communication means with a device user interface of the edge platform and/or a cloud network 246 having communicated with one or more building operator devices 248.

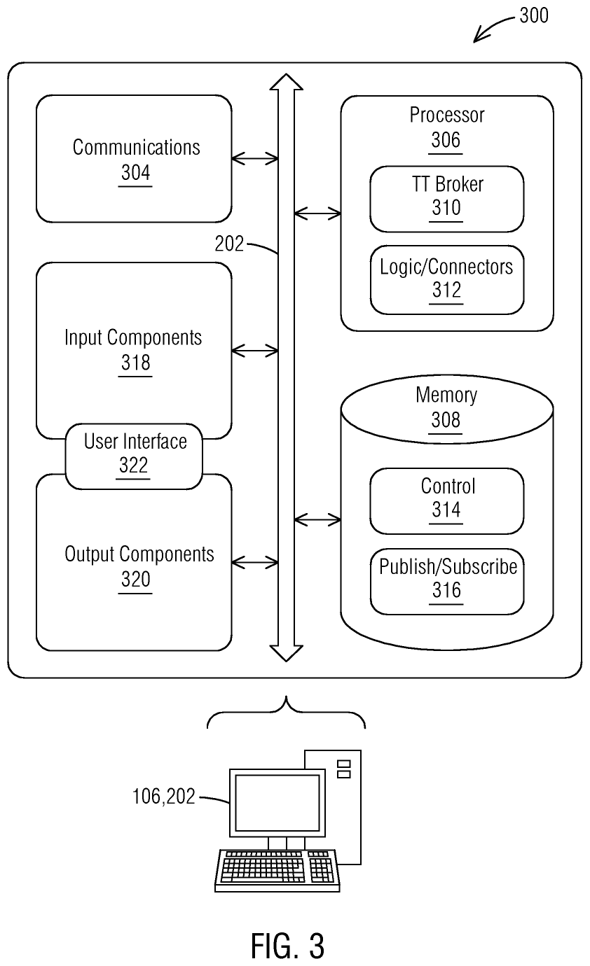

FIG. 3 represents example device components 300 of the edge platform 106, 202. The device components 300 comprise a communication bus 302 for interconnecting other device components directly or indirectly. The other device components include one or more communication components 304 communicating with other entities via a wired or wireless network, one or more processors 306, and one or more memory components 308. The communication component 304 communicates (i.e., receives and/or transmits) data associated with one or more devices and networks of the building management system 100, such as gateways, manage devices, and external devices and networks. The communication component 304 may utilize wired or wireless technology for communication.

The processor or processors 306 may execute code and process data received from other components of the device components 300, such as information received at the communication component 304 or stored at the memory component 308. The code associated with the edge platform 106, 202 and stored by the memory component 308 may include, but is not limited to, operating systems, applications, modules, drivers, and the like. An operating system includes executable code that controls basic functions, such as interactions among the various components of the device components 300, communication with external devices via the communication component 304, and storage and retrieval of code and data to and from the memory component 308.

Each application includes executable code to provide specific functionality for the processor 306 and/or remaining components of the edge platform 106, 202. Examples of applications executable by the processor 306 include, but are not limited to, a telemetry transport broker module 310 and an edge logic/data connectors module 312. The telemetry transport broker module 310 receives publication requests of telemetry transport messages from interface agents, associates the telemetry transport messages to topics of the telemetry transport broker, receives subscription requests to at least one topic of the telemetry transport broker, and forwards telemetry transport messages associated with a particular topic of the one or more topics to the interface agent or agents subscribed to the particular topic. The edge logic/data connectors module 312 manages interface agents of the edge logic components and data connector components as well as the data associated with these agents.

Data stored at the memory component 308 is information that may be referenced and/or manipulated by an operating system or application for performing functions of the edge platform 106, 202. Examples of data associated with the edge platform 106, 202 and stored by the memory component 308 may include, but are not limited to, control data 314 and publish/subscribe data 316. The control data 314 includes the operational instructions of the telemetry transport broker as well as the topics stored by the broker. The publish/subscribe data 316 includes the messages published by the interface agents to the telemetry transport broker as well as the subscriptions to topics requested by the agents.

The device components 300 may include one or more input components 318 and one or more output components 320. The input components 318 and output components 320 of the device components 300 may include one or more visual, audio, mechanical, and/or other components. For some embodiments, the input and output components 318, 320 may include a user interface 322 for interaction with a user of the device. The user interface 322 may include a combination of hardware and software to provide a user with a desired user experience.

It is to be understood that FIG. 3 is provided for illustrative purposes only to represent examples of the edge platform 106, 202 and is not intended to be a complete diagram of the various components that may be utilized by the system 100. Therefore, the edge platform 106, 202 may include various other components not shown in FIG. 3, may include a combination of two or more components, or a division of a particular component into two or more separate components, and still be within the scope of the present invention.

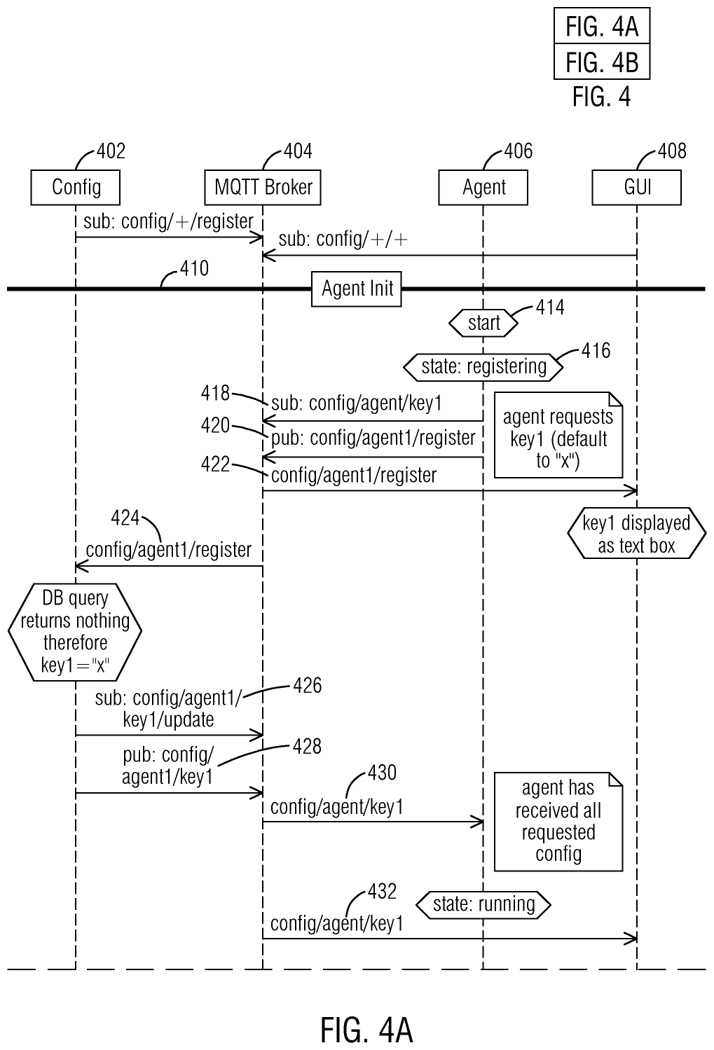

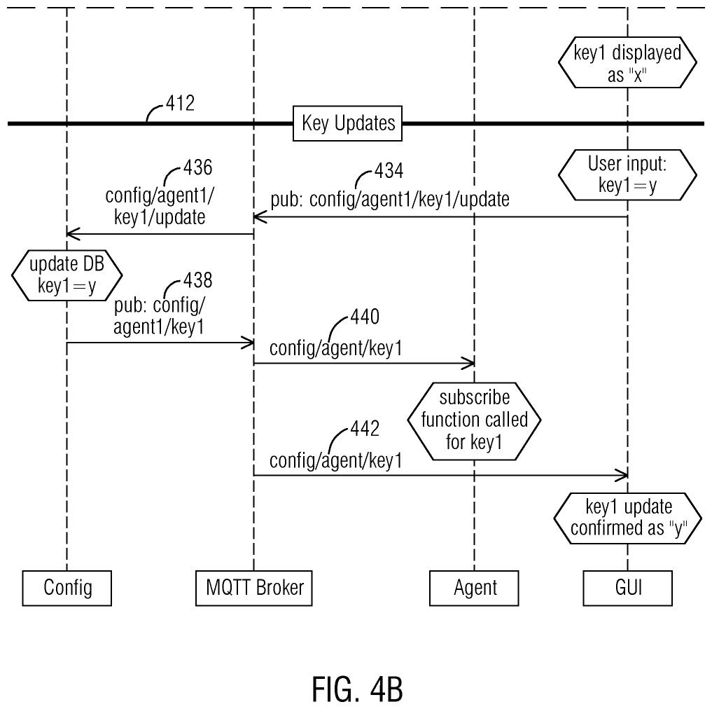

Referring to FIG. 4 (including FIGS. 4A and 4B), there is shown a flow diagram depicting first operations 400 of the telemetry transport broker interacting with various agents of the edge platform for agent initialization and key updates. The devices and components involved with the first operations 400 include a configuration agent 402, a telemetry transport broker 404, an individual agent 406 representing one of many possible interface agents, and an edge platform device 408. The first operations 400 of the telemetry transport broker 404 include an operation for agent initialization (410) and an operation for key updates (412).

For the operation of agent initialization (410), the process may be started (414) by the individual agent 406 during a registering state (416). The individual agent 406 provides a subscribe message (418) of a key and a publish message (420) of a register to the broker 404. The broker 404 provides a register message (422) to the edge platform device 408 in response to receiving the publish message (420). The broker 404 also provides a register message (424) to the configuration agent 402 in response to receiving the publish message (420). The configuration agent 402 checks with the database of the edge platform and provides a subscribe message (426) of an update and a publish message (428) of the key to the broker 404 in response to the checking the database. For example, a query to the database may return nothing, thus assigning a null or other appropriate value to the key. The broker 404 provides a key message (430) to the individual agent 406 in response to the publish message (428), thus indicating that the agent has received all requested configuration information. As a result, the individual agent 406 has a running state. Also, the broker 404 provides the key message (432) to the edge platform device 408 so that the value of the key may be output at the device.

For the operation of key updates (412), the edge platform device 408 provides a publication message (434) of a key of an update to the broker 404 in response to a user input. The broker 404 provides an update message (436) to the configuration agent 402 in response to the publish message (434). The configuration agent 402 checks with the database and provides a publish message (438) of the key to the broker 404 in response to checking the database. The broker 404 provides a key message (440) to the individual agent 406, thus subscribing a function call for the key. The broker 404 also provides a key message (442) to the edge platform device 408, thus confirming the key update.

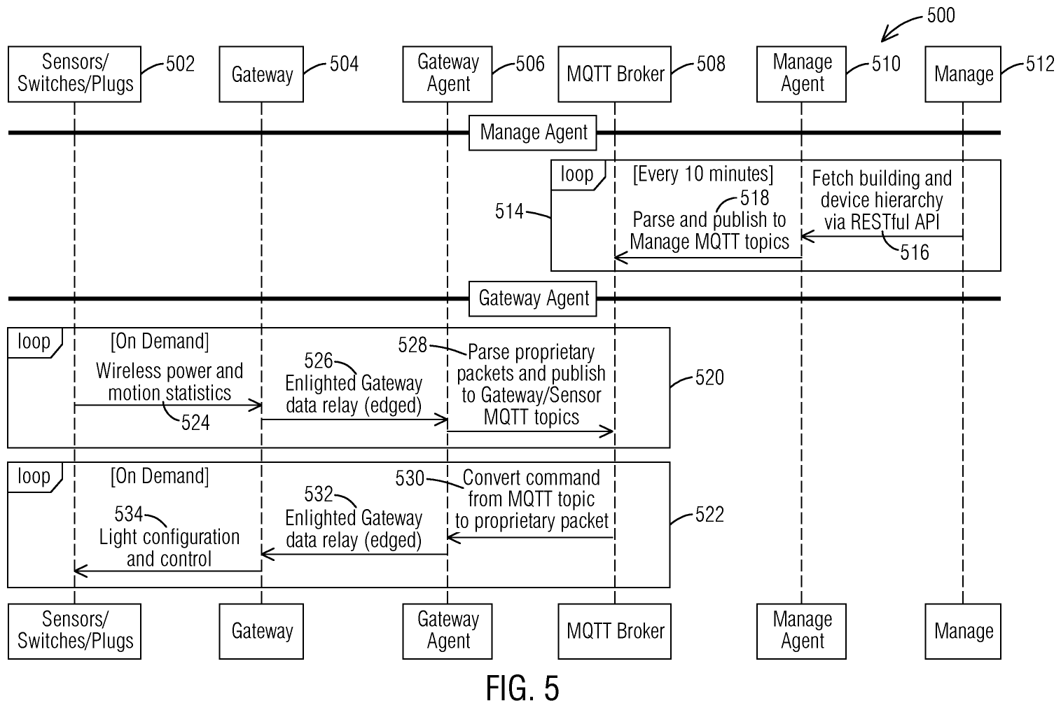

Referring to FIG. 5, there is shown a flow diagram depicting second operations 500 of the telemetry transport broker interacting with a manage agent, gateway agent, and associated components of the edge platform. The devices and components involved with the second operations 500 include one or more field devices 502, a gateway 504, a gateway agent 506, a telemetry transport broker 508, a manage agent 510, and a manage device 512. The second operations 500 of the telemetry transport broker 508 include an operation (514) for the manage agent 510, a first operation (520) for the gateway agent 506, and a second operation for the gateway agent (522).

For the operation (514) for the manage agent 510, the manage device 512 provides a fetch message (516) to the manage agent 510 to receive building and device hierarchy data. The manage agent 510 parses the building and device hierarchy data and publishes the data (518) to the broker 508 in response to the fetch message (516).

For the first operation (520) for the gateway agent 506, the gateway 504 receives field device data (524) from the field devices 520, such as power and motion statistics detected or determined by the field devices. The gateway 504 provides the data (526), as received or after processing, to the corresponding gateway agent 506 of the edge platform in response to receiving the field device data (524). The gateway agent 506 parses the field device data and publishes the data (528) to the broker 508, particularly for an appropriate topic of the broker, in response to the receiving the data (526).

For the second operation (522) for the gateway agent 506, the broker 508 may also provide a command (530) from a topic to the gateway agent 506. The gateway agent 506 may provide the command (532) to the gateway 504 in response to the command (530). The gateway 504 may provide the command (534), as received or after processing, to one or more field devices 502 in response to receiving the command (532). An example of the command is, but is not limited to, light configuration and control.

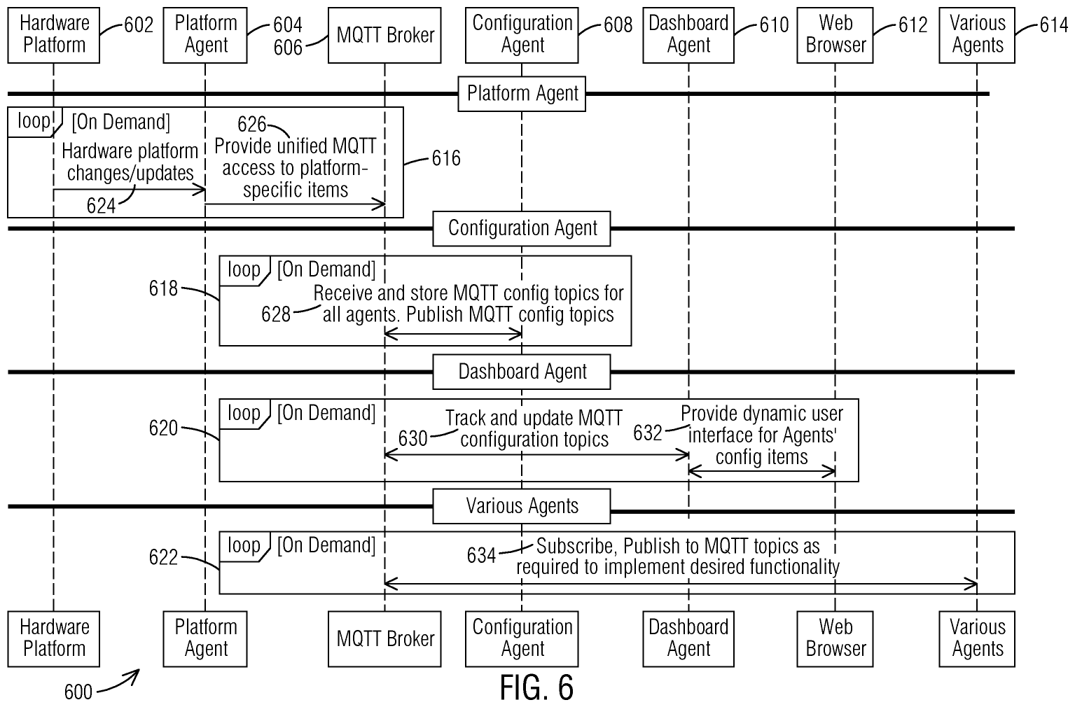

Referring to FIG. 6, there is shown a flow diagram depicting third operations 600 of the telemetry transport broker interacting with a platform agent, configuration agent, dashboard agent, various agents, and associated components of the edge platform. The devices and components involved with the third operations 600 include a hardware platform 602 (such as an edge interface), a platform agent 604, a telemetry transport broker 606, a configuration agent 608, a dashboard agent 610, a remote edge platform device 612, and various agents 614. The third operations 600 of the telemetry transport broker 606 include an operation 616 for platform agent 604, an operation 618 for the configuration agent 608, an operation 620 for the dashboard agent 610, and an operation 622 for various agents 614. For the operation 616 of the platform agent 604, the platform agent provides unified access (626) to platform-specific items of the broker 606 in response to receiving hardware platform changes or updates (624) from the hardware platform 602. For the operation 618 of the configuration agent 608, the broker 606 receives and stores telemetry transport configuration topics (628) for all agents from the configuration agent, and the configuration agent publishes telemetry transport configuration topics (628) at the broker. For the operation 620 of the dashboard agent 610, the broker 606 and the dashboard agent 610 track and update telemetry transport configuration topics (630), and the dashboard agent and the remote edge platform device 612 communicate dynamic user interface information (632) for configuration items of the interfacing agents. For the operation 622 of the various agents 614, the various agents need to publish telemetry transport topics and subscribe to telemetry transport topics (634) to implement desired functionality of the edge platform.

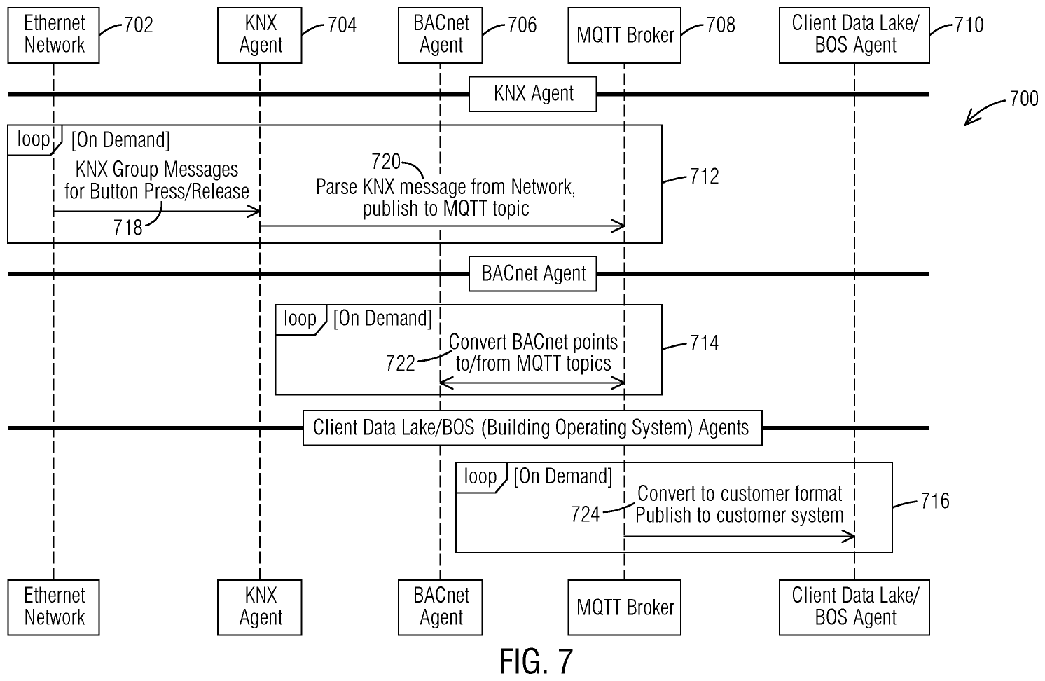

Referring to FIG. 7, there is shown a flow diagram depicting fourth operations 700 of the telemetry transport broker interacting with a KNX agent, BACnet agent, client data lake/BOS agent and associated components of the edge platform. The devices and components involved with the fourth operations 700 include a network 702, a KNX agent 704, a BACnet agent 706, a telemetry transport broker 708, and a device/network agent 710. The fourth operations 700 of the telemetry transport broker 708 includes an operation 712 of the KNX agent 704, an operation 714 of the BACnet agent 706, and an operation 716 of the device/network agent 710. For the operation 712 of the KNX agent 704, the KNX agent 704 parses a KNX message received from the network 702 and publishes the parsed KNX message to a telemetry transport topic of the broker 708 (720) in response to receiving one or more KNX message or KNX group messages (718) from the network. An example of a KNX message is, but is not limited to, a message associated with button selection and/or deselection. For the operation 714 of the BACnet agent 706, the BACnet agent 706 and the broker 708 may exchange messages to convert BACnet points (722) to and/or from telemetry transport topics of the broker. For the operation 716 of the device/network agent 710, the broker 708 may convert data of the building automation system to an external format and provide the data (724) to the device/network agent 710 of the external network.

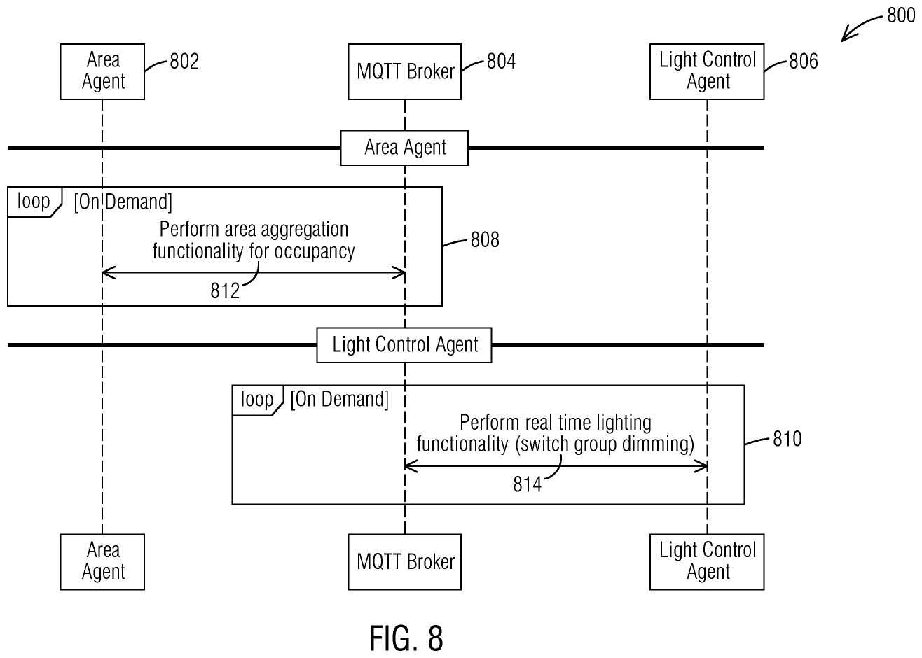

Referring to FIG. 8, there is shown a flow diagram depicting fifth operations 800 of the telemetry transport broker interacting with an area agent, light control agent, and associated components of the edge platform. The devices and components involved with the fifth operations 800 include an area agent 802, a telemetry transport broker 804, and a lighting control agent 806. The fifth operations 800 of the telemetry transport broker 804 includes an operation 808 of the area agent 802 and an operation 810 of the lighting control agent 806. For the operation 808 of the area agent 802, the area agent and the broker 806 perform area aggregation functionality (812) for one or more buildings. For example, the area agent 802 may receive occupancy data from the field devices of an external network and publish the occupancy data, as received or after processing, to the broker 804. For the operation 810 of the lighting control agent 806, the broker 804 and the lighting control agent 806 may perform real time lighting functionality (814) for one or more buildings. For example, the lighting control agent 806 may receiving lighting condition information from the field devices of an external network and publish the information, as received or after processing, to the broker 804. As another example, the lighting control agent 806 may provide lighting controls to subscribers of lighting topics of the broker 804, via the external network, so that the lighting capabilities of the field devices (such as dimming levels of switch groups) may be managed.

Those skilled in the art will recognize that, for simplicity and clarity, the full structure and operation of all data processing systems suitable for use with the present disclosure are not being depicted or described herein. Also, none of the various features or processes described herein should be considered essential to any or all embodiments, except as described herein. Various features may be omitted or duplicated in various embodiments. Various processes described may be omitted, repeated, performed sequentially, concurrently, or in a different order. Various features and processes described herein can be combined in still other embodiments as may be described in the claims.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an example embodiment of the present disclosure has been described in detail, those skilled in the art will understand that various changes, substitutions, variations, and improvements disclosed herein may be made without departing from the spirit and scope of the disclosure in its broadest form.

### Edge Topics—Edge Device Configuration and Control

Agent Status MQTT Topics
Monitoring the Edge Device gateway agents

| Topic | Role | Description |
|---|---|---|
| agent/GW-<MAC>/status | Sub | Status of a gateway with MAC |
| | | address <MAC> |

Edge MQTT Topics
Configure, control, and monitor Edge device

| Topic | Role | Description |
|---|---|---|
| edge/info/edge | Sub | General information about the |
| | | Edge device. |
| edge/info/agents | Sub | List of agents currently running |
| | | (with subtopics giving details |
| | | on the individual agents). |
| edge/cmd/. . . | Pub | Generic parent topic for commands, |
| | | subtopics/commands to be added in |
| | | the future |
| edge/status | Sub | Periodic status reports from Edge. |

### Manage Topics—Site Information and Control

Manage MQTT Topics
Handled by Manage Agelnt

| Topic | Role | Description |
|---|---|---|
| manage/info/hierarchy | Sub | Manage hierarchy |
| manage/info/devices | Sub | Array of all devices |
| manage/info/switchgroups | Sub | Array of all switch groups |
| manage/info/fixtures | Sub | Array of all fixture classes |
| manage/cmd/refresh | Pub | Publishing to this topic requests |
| | | the Edge device refresh the info |
| | | topics {“val”: true} |

### Persistent Topics

Gateway MQTT Topics

| Topic | Role | Description |
|---|---|---|
| gw/<ID>/info | Sub | Semantic representation of Gateway |
| | | Specific data. |
| gw/<ID>/cmd/. . . | Pub | Parent topic for Gateway JSON |
| | | commands (Sub-topics TBD) |
| gw/<ID>/status | Sub | Status from gateway (uptime, load, |
| | | memory usage) |

Sensor MQTT Topics

| Topic | Role | Description |
|---|---|---|
| sensor/<ID>/cmd/ | Pub | Set A/B light levels for sensor's fixture |
| dimlevel | | |
| sensor/<ID>/cmd/ | Pub | Set the sensor to automatic control mode. |
| lightcontrolmode | | To enter override mode, publish to the |
| | | dimlevel topic |
| sensor/<ID>/cmd/ | Pub | Request a sensor to refresh its status |
| refresh | | data; otherwise, each sensor will send |
| | | status updates every 5 minutes |
| sensor/<ID>/status/ | Sub | Get ambient light level detected by |
| ambientlight | | sensor, in lux |
| sensor/<ID>/status/ | Sub | Get ambient temperature level in degrees |
| temperature | | Fahrenheit |
| sensor/<ID>/status/ | Sub | Get occupancy state detected by sensor. |
| occupancy | | Provides the current occupancy status |
| sensor/<ID>/status/ | Sub | Get the occupancy history over the |
| occupancy/history | | previous 5-minute interval |
| sensor/<ID>/status/ | Sub | Get the current sensor light control |
| lightcontrolmode | | mode |
| sensor/<ID>/status/ | Sub | The average load of the fixture in watts |
| power | | for the last five-minute interval |
| sensor/<ID>/status/ | Sub | Current dimming level for sensor |
| dimlevel | | |
| sensor/<ID>/info | Sub | General info about the sensor, |

ERC MQTT Topics

| Topic | Role | Description |
|---|---|---|
| erc/<ID>/info | Sub | General info about the ERC, |
| erc/<ID>/status | Sub | Status of ERC switch (including time last seen |
| | | by Edge), |

Switch Group MQTT Topics

| Topic | Role | Description |
|---|---|---|
| switchgroup/<ID>/cmd/dimlevel | Pub | Set A/B light levels for a sensors in a switch group |
| switchgroup/<ID>/cmd/dimstep | Pub | Increase or decrease the light level for switch group |
| | | by a discrete step size |
| switchgroup/<ID>/cmd/colorstep | Pub | Increase or decrease the color level for switch group |
| | | by a discrete step size |
| switchgroup/<ID>/cmd/setstate | Pub | Specify state for all fixtures of a switch group (on, off, |
| | | auto) |
| switchgroup/<ID>/cmd/scene | Pub | Select current scene for switch group |
| switchgroup/<ID>/cmd/dimop | Pub | Start and stop continuous dimming for a switch group |
| switchgroup/<ID>/cmd/colorop | Pub | Start and stop continuous color changes for a switch |
| | | group |
| switchgroup/<ID>/status/scene | Sub | Get current scene |
| switchgroup/<ID>/cmd/sceneop | Pub | Cycle to the next scene |
| switchgroup/<ID>/cmd/ramp | Pub | Start a gradual dimming and/or color change over a |
| | | specified duration |

Area MQTT Topics

| Topic | Role | Description |
|---|---|---|
| area/<ID>/cmd/. . . | Pub | Parent topic for Area JSON |
| | | commands (Sub-topics TBD) |
| area/<ID>/status/emergency | Sub | |
| area/<ID>/status/occupancy | Sub | |
| area/<ID>/status/outsensors | Sub | Number of sensors that are |
| | | not responding |

Facility MQTT Topics

| Topic | Description |
|---|---|
| campus/<ID> | These topics are returned by the manage/info |
| | hierarchy, |
| building/<ID> | representing the logical structure of the site's |
| | facilities. |
| floor/<ID> | They will initially have no publish/subscribes |
| | associated with |
| subfloor/<ID> | them but are placeholders for potential future |
| | functionality. |

### Config Topics

Config MQTT Topics
Support transfer of configuration data between client agent,
persistent data store, and dashboard accessible to a user

| Topic | Role | Description |
|---|---|---|
| config/<client-id>/register | Pub | Publishes to this topic request storage for the set of |
| | | configurations contained in the payload. After publishing, |
| | | config/<client-id>/<key> will be published with the value |
| | | stored the database (or the default specified in the |
| | | payload if none exists). |
| config/<client-id>/<key> | Sub | Key value returned from database. Each key is |
| | | published according to payload of config/<client- |
| | | id>/register. |
| config/<client-id>/<key>/update | Pub | Publish updates to key in database. Triggers a publish to |
| | | config/<client-id>/<key> after value is written to DB. |
| | | Requires that config/<client-id>/register has been |
| | | published. |

### Platform Topics

Platform MQTT Topics
Allow agent to know about platform-specific information
(e.g., network interface addresses and open ports)

| Topic | Role | Description |
|---|---|---|
| platform/network/<interface> | Sub | The IP (IPv4 and IPV6, if |
| | | available) network parameters |
| | | of each available interface. |
| platform/network/ | Sub | Inbound TCP/UDP ports open on |
| firewall/ports | | the platform. |
| platform/network/ | Sub | Request that the platform open |
| firewall/ports/request | | TCP/UDP ports. |

What is claimed is:

1. A building automation system for smart edge management comprising:
first and second interface agents receiving system data from external networks associated with field devices of one or more buildings, the first interface agent managing a first type of the system data associated with a first communication protocol and the second interface agent managing a second type of the system data associated with a second communication protocol different from the first communication protocol; and
a telemetry transport broker coupled to the first and second interface agents and a third interface agent, the first and second interface agents publishing first and second telemetry transport messages to the telemetry transport broker based on the system data and the third interface agent publishing a third telemetry transport message to the telemetry transport broker without regard to the external networks, the telemetry transport messages being associated with topics of the telemetry transport broker;
wherein at least one interface agent of the plurality of interface agents subscribe to at least one topic of the telemetry transport broker, and
wherein the telemetry transport broker forwards telemetry transport messages associated with a particular topic of the at least one topic of the telemetry transport broker to the at least one interface agent subscribed to the particular topic.

2. The building automation system as described in claim 1, wherein the first interface agent manages the first type of the system data associated with an environmental network protocol for building automation.

3. The building automation system as described in claim 1, wherein the second interface agent manages the second type of system data associated with a network protocol selected from a group consisting of Building Automation and Control networks (BACnet), Konnex (KNX), Universal Device Management Interface (UDMI), or Digital Twin Definition Language (DTDL).

4. The building automation system as described in claim 1, wherein the third interface agent is a lighting control agent for the one or more buildings, the third interface agent subscribing to at least one topic of the telemetry transport messages associated with the field devices of the one or more buildings.

5. The building automation system as described in claim 1, wherein the third interface agent is a configuration agent for managing configuration parameters for all interface agents publishing and/or subscribing to the telemetry transport broker.

6. The building automation system as described in claim 1, wherein the at least one topic of the telemetry transport broker includes at least one selected from a group consisting of a gateway topic, a sensor topic, a room control topic, switch group topic, an agent topic, an area topic, a configuration topic, or a platform.

7. The building automation system as described in claim 1, further comprising a gateway for communicating the system data from the external networks associated with field devices of one or more buildings to the first interface agent.

8. A method of a building automation system for smart edge management, the method comprising:
receiving, at first and second interface agents, system data from external networks associated with field devices of one or more buildings, the first interface agent managing a first type of the system data associated with a first communication protocol and the second interface agent managing a second type of the system data associated with a second communication protocol different from the first communication protocol;
publishing telemetry transport messages at a telemetry transport broker by the first and second interface agents based on the system data and by a third interface agent without regard to the external networks, the telemetry transport messages being associated with topics of the telemetry transport broker;
subscribing to at least one topic of the telemetry transport broker by at least one interface agent of the plurality of interface agents,
forwarding, by the telemetry transport broker, telemetry transport messages associated with a particular topic of the at least one topic of the telemetry transport broker to the at least one interface agent subscribed to the particular topic.

9. The method as described in claim 8, wherein the first interface agent manages the first type of the system data associated with an environmental network protocol for building automation.

10. The method as described in claim 8, wherein the second interface agent manages the second type of system data associated with a network protocol selected from a group consisting of Building Automation and Control networks (BACnet), Konnex (KNX), Universal Device Management Interface (UDMI), or Digital Twin Definition Language (DTDL).

11. The method as described in claim 8, wherein the third interface agent is a lighting control agent for the one or more buildings, the third interface agent subscribing to at least one topic of the telemetry transport messages associated with the field devices of the one or more buildings.

12. The method as described in claim 8, wherein the third interface agent is a configuration agent for managing configuration parameters for all interface agents publishing and/or subscribing to the telemetry transport broker.

13. The method as described in claim 8, wherein the at least one topic of the telemetry transport broker includes at least one selected from a group consisting of a gateway topic, a sensor topic, a room control topic, switch group topic, an agent topic, an area topic, a configuration topic, or a platform.

14. The method as described in claim 8, further comprising a gateway for communicating the system data from the external networks associated with field devices of one or more buildings to the first interface agent.

15. A non-transitory computer readable medium including executable instructions which, when executed, causes at least one processor to provide smart edge management of a building automation system by:
receiving, at first and second interface agents, system data from external networks associated with field devices of one or more buildings, the first interface agent managing a first type of the system data associated with a first communication protocol and the second interface agent managing a second type of the system data associated with a second communication protocol different from the first communication protocol;
publishing telemetry transport messages at a telemetry transport broker by the first and second interface agents based on the system data and by a third interface agent without regard to the external networks, the telemetry transport messages being associated with topics of the telemetry transport broker;
subscribing to at least one topic of the telemetry transport broker by at least one interface agent of the plurality of interface agents,
forwarding, by the telemetry transport broker, telemetry transport messages associated with a particular topic of the at least one topic of the telemetry transport broker to the at least one interface agent subscribed to the particular topic.

16. The medium as described in claim 15, wherein the first interface agent manages the first type of the system data associated with an environmental network protocol for building automation.

17. The medium as described in claim 15, wherein the second interface agent manages the second type of system data associated with a network protocol selected from a group consisting of Building Automation and Control networks (BACnet), Konnex (KNX), Universal Device Management Interface (UDMI), or Digital Twin Definition Language (DTDL).

18. The medium as described in claim 15, wherein the third interface agent is a lighting control agent for the one or more buildings, the third interface agent subscribing to at least one topic of the telemetry transport messages associated with the field devices of the one or more buildings.

19. The medium as described in claim 15, wherein the third interface agent is a configuration agent for managing configuration parameters for all interface agents publishing and/or subscribing to the telemetry transport broker.

20. The medium as described in claim 15, wherein the at least one topic of the telemetry transport broker includes at least one selected from a group consisting of a gateway topic, a sensor topic, a room control topic, switch group topic, an agent topic, an area topic, a configuration topic, or a platform.
